(19) United States
(12) Patent Application Publication
(10) Pub. No.: US 2015/0278938 A1
(43) Pub. Date: Oct. 1, 2015

(54) SOCIAL COMMUNITY INCOME DISTRIBUTION METHOD

(71) Applicant: Knorum, Inc., Budapest (HU)

(72) Inventors: Sandor Gabor TASNADI, Budapest (HU); Gabor SVED, Budapest (HU)

(21) Appl. No.: 14/283,910

(22) Filed: May 21, 2014

Related U.S. Application Data
(63) Continuation of application No. 14/225,629, filed on Mar. 26, 2014, now abandoned.

(51) Int. Cl. G06Q 40/00; G06Q 50/00

(52) U.S. Cl. CPC G06Q 40/00; G06Q 50/01

(57) ABSTRACT

A social community income distribution method is carried out by a system having one or more processors and a memory coupled to the processors. The memory stores program instructions executable by the one or more processors to implement a community administrator to record each transaction related to a realisation of income by a community and also to record activities between members of the community in order to determine how many points to award to the members for each type of activity and to keep track of the points awarded to the members of the community. Based on the points awarded, the income of the community is then distributed to the members of the community.

### CROSS-REFERENCE TO RELATED APPLICATIONS

The present application is a continuation of U.S. patent application Ser. No. 14/225,629, filed on Mar. 28, 2014, the disclosure of which is expressly incorporated by reference herein in its entirety.

### FIELD OF THE INVENTION

The present invention relates to computer systems and services and, more particularly, to distributing income among members of a community using such systems and services.

### BACKGROUND OF THE INVENTION

Communities are as old as the human race itself. Humans have formed communities because they have realised by instinct that a community is stronger, more protected and can achieve more as a group compared to mere individuals. Bonding into communities is therefore part of our heritage.

This is not different in the 21^{st} century. The Internet has enabled us to create or to join communities for any purpose. Such communities can span over many geographical areas and language barriers. The cost of entering such communities is very low or even zero. These modern communities are often called “social communities”. They typically involve a large number of members (users) that interact with each other over the Internet and share certain attributes, e.g. a hobby.

Most communities are formed on a not-for-profit basis. However, there are communities with the primary or secondary aim of earning money. Whenever there is income in a community, the question arises if and how to distribute this income among community members. The most common method of such an income distribution is based on member-contribution (i.e. the income is distributed to the member that has generated it) which has several shortcomings. While a member-contribution based distribution system seems fair on an individual basis, it does not consider the social aspects of the community, nor does it motivate all community members to be actively involved in the community's social, non-revenue generating activities.

The present invention discloses a system and method of a social community income distribution method whereas the revenue generated by the community is distributed among members based on each member's (social) contribution to the community.

### SUMMARY OF THE INVENTION

The present invention seeks to overcome various limitations of the prior art. Generally speaking, the invention provides a method and system for distributing income of a social community based on each member's non-financial contribution to the community. Various embodiments of systems and methods for social community income distribution method are disclosed.

According to one embodiment, a system includes one or more processors and a memory coupled to the processors, where the memory stores program instructions executable by the processors to implement a community Administrator. The system can operate over the Internet or any other network of linked micro-processors which can reference a database. The system also has application to other networked devices other than the Internet, such as telephones. The community Administrator is configured to manage the community's income which can consist of community sign-up fees, membership fees or other income realised through any independent third party (e.g. outside advertising revenues).

The Administrator is managing the activities among the members. Such an activity can be, for example, a question from member A to member B but also the answer from member B to member A. This exchange is considered an activity. Members are awarded points by the Administrator for each social activity. The Administrator determines how many points each social activity is worth based on a ‘price list’ and keeps track of all points awarded. Based on the number of awarded points, the Administrator then determines how much each member has contributed to the community, i.e. to the other members of the community.

In one embodiment, the Administrator may also measure the reaction speed of member activity. The time is measured how fast a community member reacts to other members' requests. The faster the reaction, the more points are awarded to the acting member.

In another embodiment, the Administrator may ask other members to rate the quality of a community member's activity through a feedback system. The better the rating the more points are awarded to the acting member.

In yet another embodiment, the Administrator may differentiate between each member's geographical location or the geographical location linked to the activity. The same activity may be awarded more points in some geographical locations than in others.

In still yet another embodiment, the Administrator may use point inflation or deflation and start to award more or less points to each social activity over time.

In a further embodiment, the Administrator may use promotional offers for certain community activities (e.g. 20% more points than usual for a certain activity for a limited or unlimited period of time).

In a still further embodiment, the Administrator may use half-value periods meaning that a member can lose points over time if certain minimum criteria for social activity are not met.

The basis for the distribution of the social community income is the point balance of each community member. In order to be able to execute the distribution, the Administrator also keeps track of the distributed income balance of each community member. In one embodiment, the Administrator may use discrete time-intervals (e.g. weekly, every 2^{nd} Monday of the month, etc.) to distribute income among the members of the community. The Administrator sets the distribution schedule and keeps track of all incremental community income and all incremental member points until the next distribution date. On the distribution date, the Administrator calculates the total incremental income of the community and divides it by the total incremental points the members of the community have been awarded since the last distribution date. The Administrator then determines the distributed income per member by multiplying the result with the incremental number of points of each member. In a final step, the distributed income of each member is added to the previously distributed income balance of said member. In another embodiment, the Administrator may use continuous real-time intervals to execute the income distribution. In this case, the income distribution is executed by the Administrator after each community income transaction.

In one embodiment, members may be required to reactivate their account balance prior to income distribution by executing an action step required by the Administrator. Members may lose some of their points or all their points if such reactivation is not executed within the time frame provided by the Administrator.

In another embodiment, members have the option to ask the Administrator to transfer out all or parts of their distributed income to their private bank account. After the income is transferred, members lose all points with which the distributed income was realised.

### REFERENCES TO EXISTING PATENTS

There are several patents that describe systems which share one or more attributes with the present system and method. However, none of them has the same objective of income distribution in a social community.

U.S. Pat. No. 8,224,696 to Michael L. Speiser et al. describes an automated reward management system for contests. A contest manager is collecting entry fees of which a portion is distributed as prizes among contest winners. In this context, the contest is not a social community and the distribution of the prizes is based on user feedback on perceived contestants' skills and not on the social activity that is beneficial for the community as a whole. Also, the contest manager does not award points as incentives for all users to become involved in user activities.

U.S. Pat. No. 6,343,990 to Sean Rasmussen et al. describes an entertainment system offering merit-based rewards. Participants submit content to a website and vote for the best contents. The winners receive a payout that is preferably funded by fees collected for accessing the website. In this context, the users do not form a social community and the distribution of the prizes is based on user votes on perceived entertainment values and not on the social activity that is beneficial for the community as a whole.

U.S. Pat. No. 7,624,038 to Wood et al. describes an interactive reward system and method. Promoters allocate awards to users based on desired user activities defined by the promoters. Awards collected by users can be redeemed at the promoters' computers. This system intends to provide an incentive scheme to reward users who interact with advertisements. This system does not represent a social community and involves no distribution of income between members.

U.S. Pat. No. 8,150,750 to Ray describes systems and methods for managing expert content. Communities of experts receive consultation requests. Experts receive for their consultation responses fractional ownership in a value-added investment vehicle that is linked to the value of the responses. While experts form a community, the purpose of this community is to respond to outside requests. Thus, the experts' activity cannot be classified as a social activity conducted for the overall community's benefit. Furthermore, as experts are awarded fractional ownership based on their projects, a distribution of community income is not within the scope of the invention.

### BRIEF DESCRIPTION OF THE DRAWINGS

The foregoing and other aspects of the invention are discussed in greater detail below with reference to the accompanying drawings, provided for the purpose of description and not of limitation, wherein:

FIG. 1 is a schematic diagram illustrating the components of the social community income distribution system according to one embodiment;

FIG. 2 illustrates an example of a community member activity flow that is presented in the one embodiment;

FIG. 3 is a schematic diagram illustrating an example of income distribution according to the one embodiment; and

FIGS. 4A-4D illustrate various schematic devices, user interface screens or web pages employed by the one embodiment of the income distribution system.

While the invention is susceptible to various modifications and alternative forms, specific embodiments are shown by way of example in the drawings and are herein described in detail. It should be understood, however, that the drawings and the detailed description relating thereto are not intended to limit the invention to the particular form disclosed, but on the contrary, the invention is intended to cover all modifications, equivalents and alternatives falling within the spirit and scope of the present invention, as defined by the appended claims.

### DETAILED DESCRIPTION OF PREFERRED EMBODIMENTS

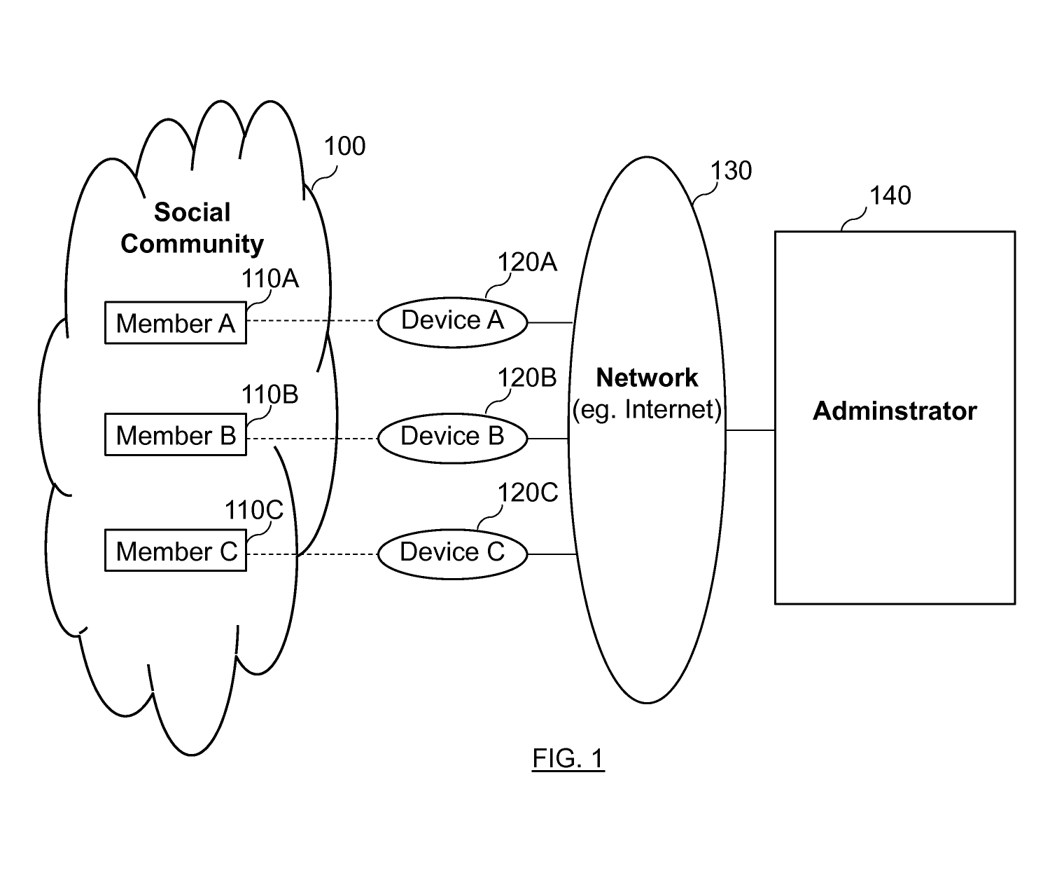

FIG. 1 shows the components of the social community income distribution system. The social community 100 may be formed by a plurality of members 110A, 110B and 110C. These members may use devices 120A, 120B and 120C to connect to each other via a network (e.g. Internet) 130. The community is overseen by an Administrator 140 that may be connected to the devices 120A, 120B and 120C through the network 130 as well.

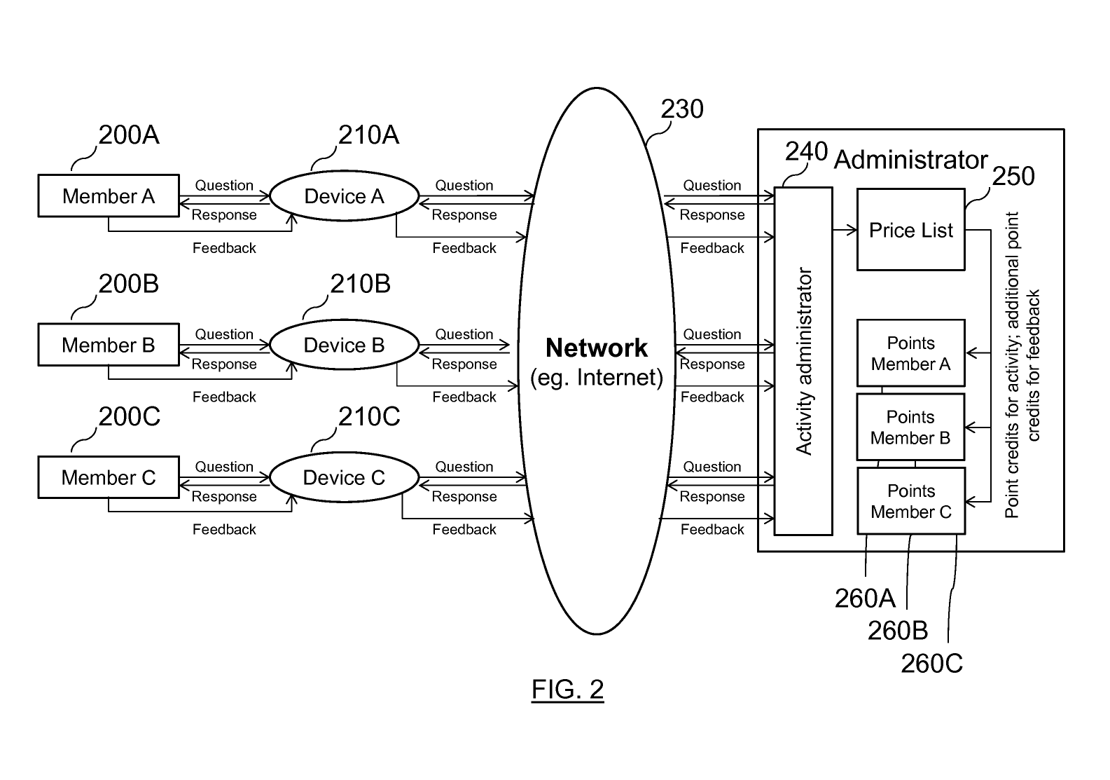

FIG. 2 shows an example of member activity flows. Members of the community 200A, 200B and 200C may be engaged in an activity such as submitting a question to the community. Members 200A, 200B and 200C may use their devices 210A, 210B and 210C for such submissions. The devices 210A, 210B and 210C may connect to the Administrator 240 through a network 230. The network 230 may be a physical network or a transmitting medium (e.g. air). In FIG. 2, the Administrator 240 receives the question and may route it to another member or a plurality of members of the community. At the same time, the Administrator 240 may look up the point value of the question from a price list 250, may determine the member that those points should be credited to, and may post these points to an internal account of the respective member 260A, 260B and 260C. The price list 250 may contain positive, zero or negative point values as well. After a member or a plurality of members receives the question, they may engage in a new activity like submitting an answer to the question. The same process as described before may be started again: the member's device may send the answer through the network 230 to the Administrator 240 and the Administrator 240 may relay the answer to the asking member of the community. The Administrator 240 may look up the price list 250 and may determine a point value of the replying member's activity. The Administrator 240 may then credit these points to the replying member's internal account. All participating members may give feedback to other members about their activities. The feedback process may work in an identical way as the activity process described above.

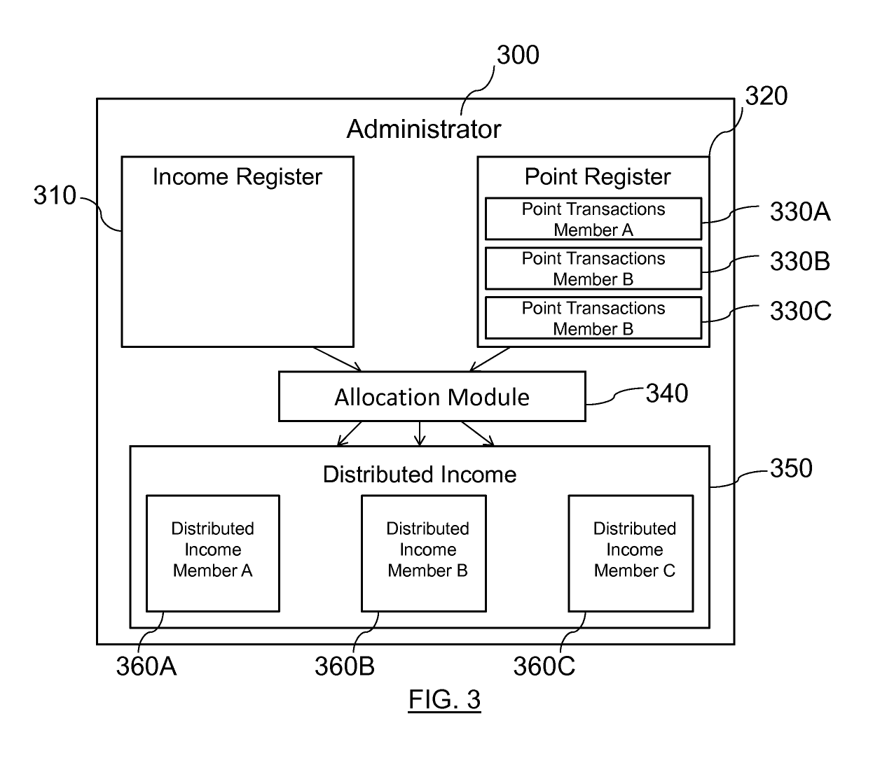

FIG. 3 illustrates the system and method of income distribution according to another embodiment. An Administrator 300 may keep track of all income, in an income register 310, realized by the social community. As previously described in FIG. 2, the Administrator may keep individual internal accounts in a point register 320 for each community member. The point register 320 contains each point transaction and the total number of points for each member 330A, 330B and 330C. An allocation module 340 may distribute the total or a part of income 350 to all or a specific plurality of members based on each member's share of the total point balance accumulated. After the distribution process is finished, the point account balances may be reset by the Administrator 300 to zero. The distributed income per member 360A, 360B and 360C may be kept recorded separately by the Administrator 300. Members may have the option to withdraw their income from their income account through a process that may be controlled and executed by the Administrator 300.

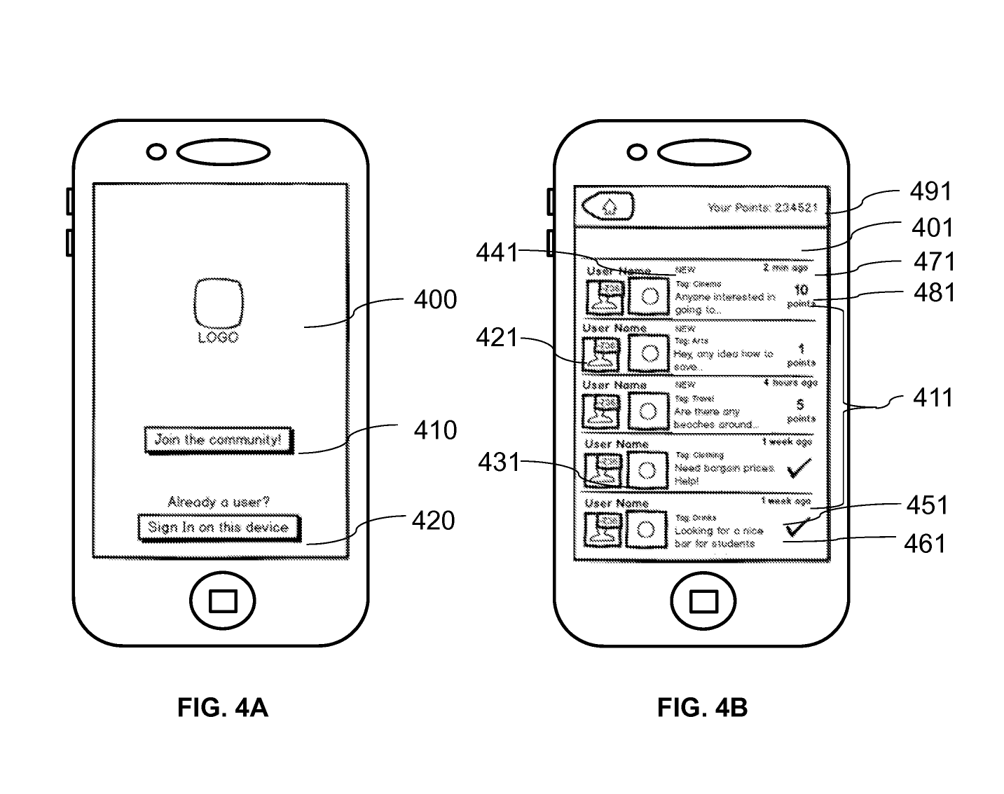

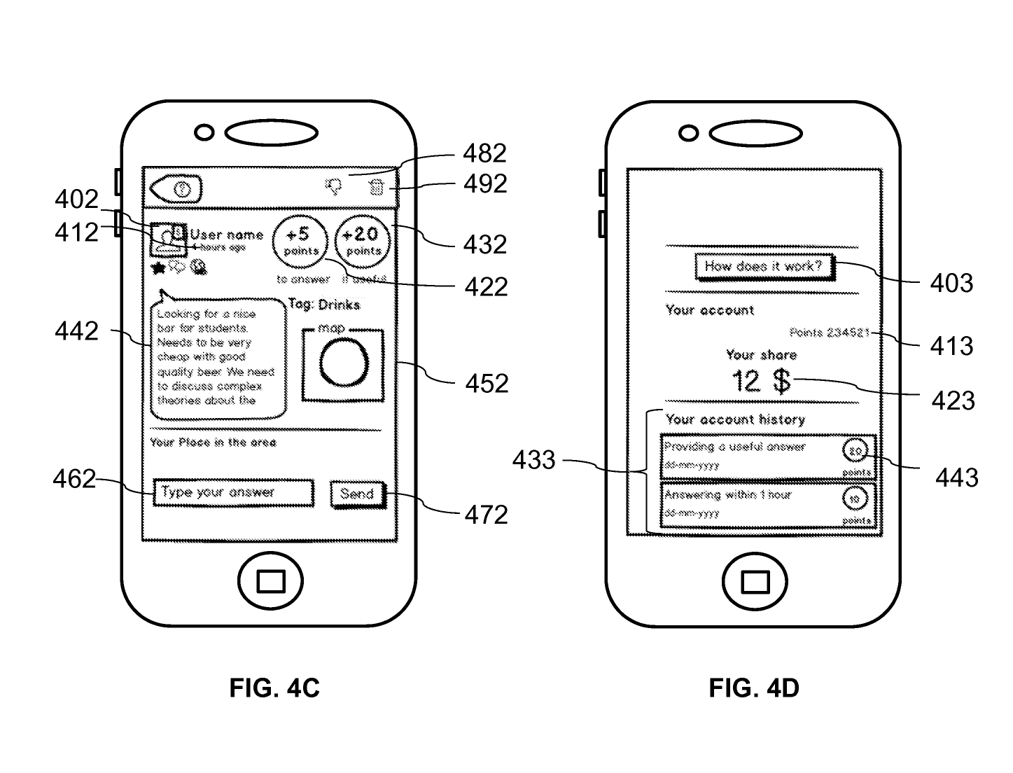

FIG. 4A illustrates the schematics of an exemplary member device interface 400. Members accessing the interface 400 sign up as members of the social community by pushing a join button 410. Existing members of the community can bypass the sign up process by pushing a sign-in button 420 on the interface 400. In this case, members may be authenticated by asking them to enter their credentials, such as name, email address and password.

FIG. 4B illustrates an example for a member interface 401 through which member activities may be executed. Requests 411 from other members asking the social community for help may be listed. Each list entry may show a profile picture (avatar) 421 of the asking member. Additionally, a small map 431 may be displayed to indicate the geographical location to which the help request may refer to. Unread requests may be marked as new messages 441. Each request 411 may have one or more tags 451 to categorize the request 411 for the receiving member. Tags 451 may be defined by the Administrator as a closed tag system or created by the members as an open tag system. A short description 461 of the request 411 may be displayed as well. Information about an age 471 of the request 411 may be shown alongside the information on how many points 481 may be earned by becoming engaged in the activity of helping the asking member. The interface 401 may show the total point balance 491 of the member. By clicking into each element of the list, a more detailed description of the request 411 may be pulled up.

FIG. 4C is an example for a device interface with detailed information on received requests 422 and input fields for replying to these requests 422. A profile picture (avatar) 402 of the member requesting help may be displayed alongside with aging information 412 of the request 422. Points information linked to the request 422 may be shown as set by the Administrator. Additional points 432 may be offered if the member's activity receives positive feedback through the built-in feedback loop. A complete description 442 of the request 422 may be displayed. Additionally, a small map 452 may be displayed to indicate the geographical location to which the help request may refer to. The member operating the interface has the option to reply to the request 422 by typing an answer into an answer box 462. By pushing a send button 472, the answer is sent to the Administrator which relays the answer to the member that initialized the request. The Administrator keeps track of the processes and the point transactions linked to the member activities. The acting member may push an abuse button 482 to report if an activity is considered abusive (e.g. illegal, unsolicited, non-complying to social norms, etc.). The member may also delete the request 422 by pushing a delete button 492.

FIG. 4D illustrates a user's device interface displaying point account balance transactions to the individual member. By pressing a help button 403, further information about the point transaction process and the income distribution method may be displayed. An actual total point balance 413 may be shown to the community member. The member may also see total income 423 that may have been distributed to the member in one, more or all previous transactions. Additionally, an account history 433 may be displayed showing line-by-line each point transaction 443 that the Administrator may have recorded for the respective member.

Although the embodiments above have been described in considerable detail, numerous variations and modifications will become apparent to those skilled in the art once the above disclosure is fully appreciated. It is intended that the following claims be interpreted to embrace all such variations and modifications.

1-11. (canceled)

12. A method of operating an administrator system including one or more processors and a non-transitory storage memory storing instructions, the method comprising:
recording transactions related to realization of an income by a community,
recording activities between members of the community,
determining how many points to award for each activity,
awarding points to members that have performed activities,
calculating incremental points awarded to each member over an increment of time,
calculating total incremental points for all members of the community over the increment of time,
calculating a total incremental income for the community over the increment of time,
calculating a result equal to the total incremental income divided by one of, the incremental points or the total incremental points,
calculating a distributed income for each member by multiplying the result times one of, the incremental points or the total incremental points, and
distributing the distributed income for each member to each member.

13. The method of claim 12, wherein the determining how many points to award for each activity includes consideration of a reaction speed, such that a first activity performed quickly in response to a request is awarded more points than the first activity performed slowly in response to the request.

14. The method of claim 12, wherein the determining how many points to award for each activity includes consideration of a geographic location of a member.

15. The method of claim 12, wherein the determining how any points to award for each activity includes consideration of a geographic location of the activity.

16. The method of claim 12, wherein the determining how many points to award for each activity includes point inflation over time.

17. The method of claim 12, wherein the determining how may points to award for each activity includes point deflation over time.

18. The method of claim 12, wherein each member is required to reactivate their account balance prior to receiving the distributed income for each member.

19. An administrator system comprising:
one or more processors; and
a non-transitory storage memory storing instructions that, when executed by the one or more processors, cause the following steps to be performed:
recording transactions related to realization of an income by a community,
recording activities between members of the community,
determining how many points to award for each activity,
awarding points to members that have performed activities,
calculating incremental points awarded to each member over an increment of time,
calculating total incremental points for all members of the community over the increment of time,
calculating a total incremental income for the community over the increment of time,
calculating a result equal to the total incremental income divided by one of, the incremental points or the total incremental points,
calculating a distributed income for each member by multiplying the result times one of, the incremental points or the total incremental points, and
distributing the distributed income for each member to each member.

20. The administrator system of claim 19, wherein the determining how many points to award for each activity includes consideration of a reaction speed, such that a first activity performed quickly in response to a request is awarded more points than the first activity performed slowly in response to the request.

21. The method of claim 19, wherein the determining how many points to award for each activity includes consideration of a geographic location of a member.

22. The method of claim 19, wherein the determining how many points to award for each activity includes consideration of a geographic location of the activity.

23. The method of claim 19, wherein the determining how many points to award for each activity includes point inflation over time.

24. The method of claim 19, wherein the determining how many points to award for each activity includes point deflation over time.

25. The method of claim 19, wherein each member is required to reactivate their account balance prior to receiving the distributed income for each member.
